(19) United States
(12) Patent Application Publication
(10) Pub. No.: US 2026/0131609 A1
(43) Pub. Date: May 14, 2026

(54) ROBOT APPARATUS

(71) Applicant: SAMSUNG ELECTRONICS CO., LTD., Suwon-si (KR)

(72) Inventors: Jaemyung CHO, Suwon-si (KR); Minhee LEE, Suwon-si (KR); Hyunsuk KWAK, Suwon-si (KR)

(73) Assignee: SAMSUNG ELECTRONICS CO., LTD., Suwon-si (KR)

(21) Appl. No.: 19/337,352

(22) Filed: Sep. 23, 2025

Related U.S. Application Data
(63) Continuation of application No. PCT/KR2025/012860, filed on Aug. 23, 2025.

(30) Foreign Application Priority Data
Nov. 11, 2024 (KR) 10-2024-0159053

(51) Int. Cl. B60G 5/04; B25J 5/00; B25J 9/10

(52) U.S. Cl. CPC B60G 5/04; B25J 5/007; B25J 9/106

(57) ABSTRACT

A robot apparatus may include a main body, a main hinge positioned at a lower part of the main body, a main link member having a center part coupled to the main hinge and configured to pivot about the center part, a plurality of sub-link members coupled at both sides of the main link member, and a first wheel and a second wheel connected to each of the plurality of sub-link members. Each of the plurality of sub-link members is connected to a first hinge member and a second hinge member at positions spaced apart from the main link member at the lower part of the main body, and is configured to pivot about the first hinge member and the second hinge member according to movements of the first wheel and the second wheel.

### CROSS-REFERENCE TO RELATED APPLICATIONS

This application is a bypass continuation application of International Patent Application No. PCT/KR 2025/012860, filed on Aug. 23, 2025 which claims priority to Korean Patent Application No. 10-2024-0159053, filed on Nov. 11, 2024, in the Korean Intellectual Property Office, the disclosures of which are incorporated herein by reference in their entireties.

### BACKGROUND

### 1. Field

The disclosure relates to a robot apparatus, and more particularly to a robot apparatus that includes link members to enhance structural and driving stability.

### 2. Description of Related Art

With developments in robot technology, development of robots used in various fields such as, delivery or serving are actively underway. Specifically, a key area of focus in this development is improving the structural design of a robot apparatus to stably drive the robot apparatus during operation.

Conventionally, attempts to improve driving stability of a robot apparatus were made by modifying a wheel structure of a robot, or adding suspension systems using a spring or a hydraulic cylinder, but despite the above, problems such as a robot apparatus shaking back and forth or side to side occurred. In addition, when using a typical link-based suspension structure, problems such as lateral tipping or excess oscillation of the robot may occur.

### SUMMARY

According to one or more embodiments of the disclosure, a robot apparatus may include a main body, a main hinge positioned at a lower part of the main body, a main link member having a center part coupled to the main hinge and configured to pivot about the center part, a plurality of sub-link members coupled at both sides of the main link member, and a first wheel and a second wheel connected to each of the plurality of sub-link members. Each of the plurality of sub-link members is connected to a first hinge member and a second hinge member at positions spaced apart from the main link member at the lower part of the main body, and is configured to pivot about the first hinge member and the second hinge member according to movements of the first wheel and the second wheel.

According to one or more embodiments of the disclosure, a robot apparatus may include: a main body; a first wheel and a second wheel positioned at a lower part of the main body; a main hinge positioned between the first wheel and the second wheel; a main link suspension having a central part coupled to the main hinge and configured to pivot about the central part; a first sub-link suspension mounted on the first wheel, coupled to a first opposing side of the main link suspension, and comprising a first hinge that connects the first sub-link suspension to the lower part of the main body; a second sub-link suspension mounted on the second wheel, coupled to a second opposing side of the main link suspension, and comprising a second hinge that connects the second sub-link suspension to the lower part of the main body; wherein a hinge axis of the first hinge is positioned closer to the central part of the main link suspension than a rotation axis of the first wheel, and wherein a hinge axis of the second hinge is positioned closer to the central part of the main link suspension than a rotation axis of the second wheel.

### BRIEF DESCRIPTION OF DRAWINGS

FIG. 1 is a perspective view illustrating a robot apparatus according to at least one embodiment of the disclosure;

FIG. 2 is a diagram illustrating a link coupling structure of a robot apparatus according to at least one embodiment of the disclosure;

FIGS. 3A and 3B are diagrams illustrating a link coupling structure of a robot apparatus according to at least one embodiment of the disclosure;

FIGS. 4A, 4B, and 4C are diagrams illustrating a coupling relationship of a main hinge and a main link member of a robot apparatus according to at least one embodiment of the disclosure;

FIG. 5 is a diagram illustrating a coupling relationship of a main link member and a sub-link member of a robot apparatus according to at least one embodiment of the disclosure;

FIG. 6 is a diagram illustrating a coupling relationship of a main link member and a sub-link member of a robot apparatus according to at least one embodiment of the disclosure;

FIGS. 7A and 7B are diagrams illustrating a positional relationship of a first hinge member and a second hinge member of a robot apparatus according to at least one embodiment of the disclosure;

FIG. 8 is a diagram illustrating a robot apparatus further including a support plate according to at least one embodiment of the disclosure;

FIG. 9 is a diagram illustrating a robot apparatus further including a 3-axis core robot according to at least one embodiment of the disclosure;

FIG. 10 is a diagram illustrating a robot apparatus including additional link members according to at least one embodiment of the disclosure; and

FIG. 11 is a diagram illustrating a robot apparatus including additional link members according to at least one embodiment of the disclosure.

### MODE FOR INVENTION

Various embodiments of the disclosure and terms used herein are not intended to limit the technical features described in the disclosure to specific embodiments, and it is to be understood as including various modifications, equivalents, or alternatives of the corresponding embodiments.

With respect to the description of the drawings, like reference numerals may be used for like or associated elements.

A singular form of a noun corresponding to an item may include one or a plurality of items above, unless otherwise specified.

In the disclosure, phrases such as “A or B”, “at least one of A and B”, “at least one of A or B”, “A, B, or C”, “at least one of A, B, and C”, and “at least one of A, B, or C” may respectively include any one or all possible combinations of the items listed together with the relevant phrase from among the phrases.

The term “and/or” may include a combination of a plurality of associated elements described or any element from among the plurality of associated elements described.

Terms such as “1st”, “2nd”, or “first” or “second” may be used to simply distinguish a relevant element from another relevant element, and not limit the relevant elements in other aspects (e.g., importance or order).

When a certain (e.g., first) element is indicated as being “coupled with/to” or “connected to” another (e.g., second) element, together with or without terms such as “operatively” or “communicatively”, it may be understood as the certain element being coupled with/to the another element directly (e.g., via wire), wirelessly, or through a third element.

It is to be understood that the terms such as “have” or “include” are used herein to designate a presence of a characteristic, number, step, operation, element, component, or a combination thereof, and not to preclude a presence or a possibility of adding one or more of other characteristics, numbers, steps, operations, elements, components or a combination thereof.

When a certain element is described as “coupled”, “combined”, “supported”, or “contacted” with another element, the above may include not only the elements being directly coupled, combined, supported, or contacted, but also being indirectly coupled, combined, supported, or contacted through the third element.

When the certain element is described as positioned “on” another element, the above may include not only the certain element being contacted to another element, but also other element being present between the two elements.

In the present disclosure, the term “an embodiment” is intended to encompass one or more embodiments, rather than being limited to a single example. Furthermore, features described in embodiments may be combined and implemented together.

An electronic apparatus 1 according to various embodiments will be described in detail below with reference to the drawings.

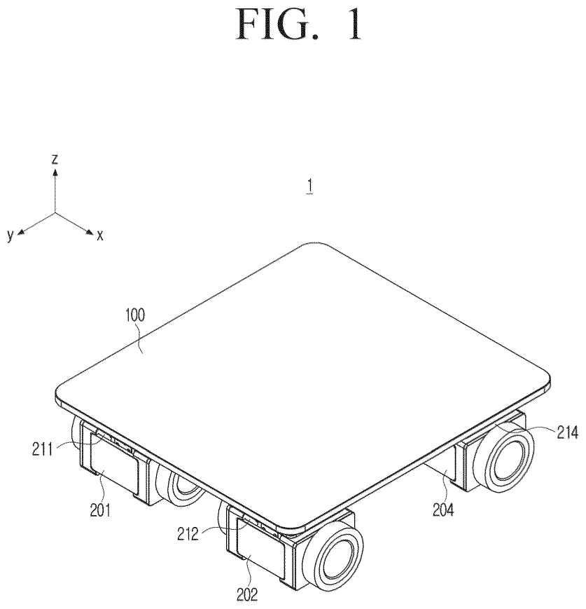

FIG. 1 is a perspective view illustrating a robot apparatus 1 according to at least one embodiment of the disclosure.

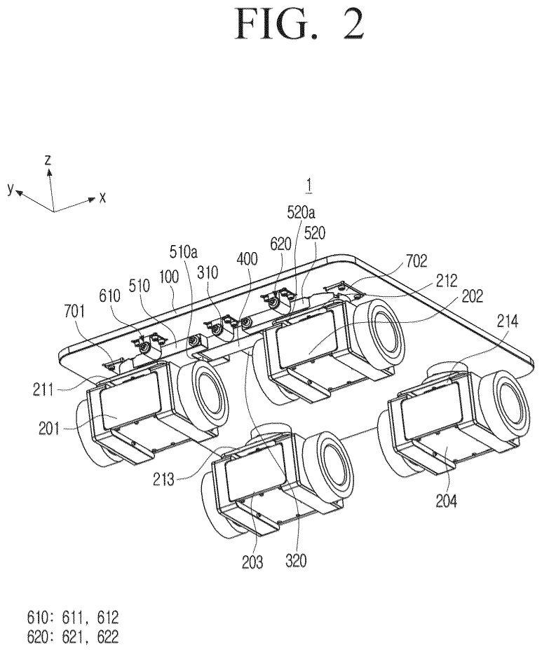

In FIG. 1, the robot apparatus 1 may include a main body 100 and a plurality of wheels 201, 202, 203 and 204, wherein the wheel 203 is shown in FIG. 2. In the robot apparatus 1 of FIG. 1, the main body 100 may be a part that receives configurations necessary for driving, for example, configurations such as the plurality of wheels 201, 202, 203, and 204.

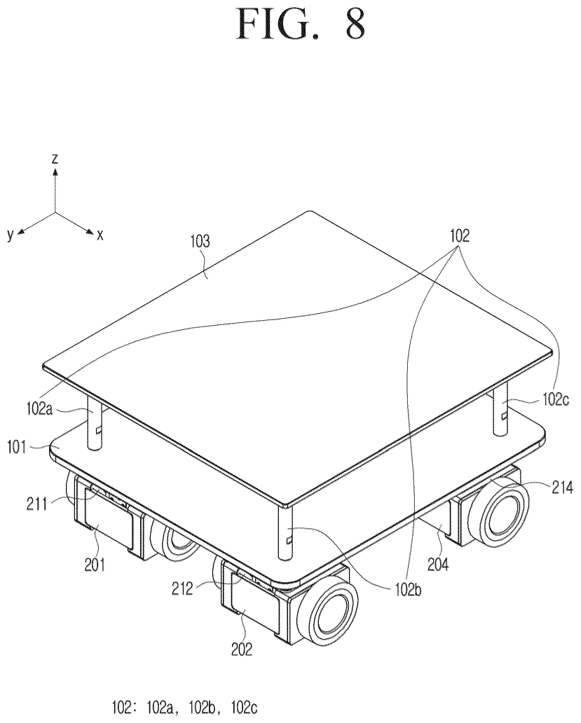

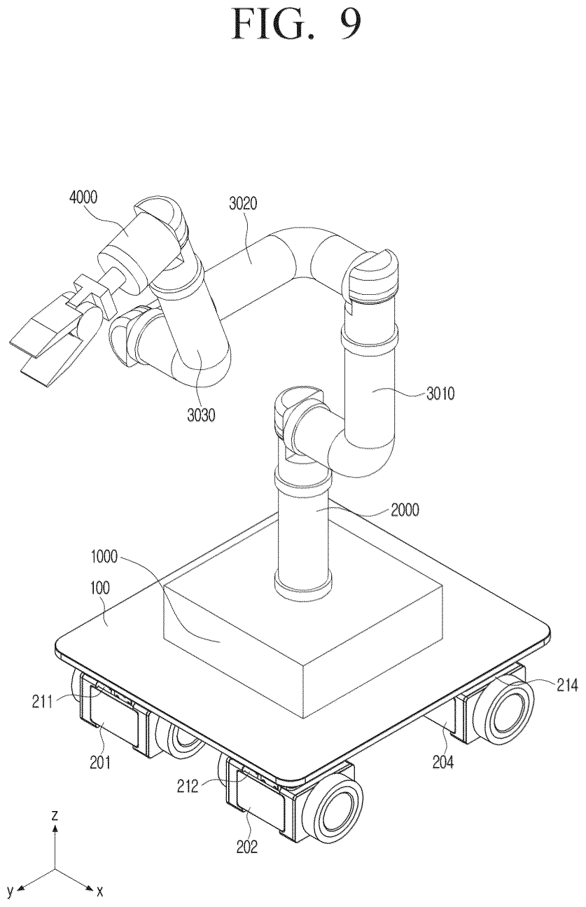

The main body 100 may otherwise be various described such as, for example, and without limitation as a support plate, a wheel base, a housing, a case, and the like, but will be described as the main body 100 in the disclosure. For convenience of description, in FIG. 1, the main body 100 has been shown with no structure whatsoever added thereon, but various devices or members may be coupled onto the main body 100 according to use or type, and the like of the robot apparatus 1. For example, a humanoid device may be assembled at an upper part of the support plate. However, the embodiment is not limited thereto, and various devices such as, for example, and without limitation, a 3-axis core robot, a support, a transport support, and the like may be assembled at the upper part of the support plate. The above will be described again in detail in FIG. 8 and FIG. 9 which will be described below.

In FIG. 1, the plurality of wheels 201, 202, 203, and 204 may be arranged such that two wheels are positioned at the front of a lower part of the main body 100 and two are at the rear of the lower part of the main body 100. A first wheel 201 and a second wheel 202 may be arranged at the front, and a third wheel 203 and a fourth wheel 204 may be arranged at the rear of the lower part of the main body 100. The third wheel 204 and the fourth wheel 204 may be arranged at a position spaced apart from the first wheel 201 and the second wheel 202.

In FIG. 1, the plurality of wheels 201, 202, 203, and 204 may include wheel bodies 211, 212, 213, and 214, respectively, wherein the wheel body 213 is shown in FIG. 2. In addition, each of the plurality of wheels 201, 202, and 204 may be configured as a differential wheel module. A differential wheel module may refer to a wheel structure that includes a main wheel body and a pair of sub-wheels (or auxiliary wheels) positioned on either side of the wheel body. This configuration allows for enhanced maneuverability, such as independent rotation or directional changes, and improves the ability of the robot apparatus 1 to perform complex movements, including turning in place or rotating with minimal lateral movement. The differential wheel module may include a plurality of wheels arranged at both sides based on the wheel bodies 211, 212, 213, and 214. To distinguish components, the main wheels 201 and 202 may be referred to as a first wheel module and a second wheel module, respectively, while the sub-wheels are designated as part of the differential structure.

In FIG. 1, the differential wheel module of the plurality of wheels 201, 202, 203, and 204 may rotate in a clockwise direction or an counter-clockwise direction about the wheel bodies 211, 212, 213, and 214. For example, the differential wheel module of the first wheel 201 may rotate 360 degrees left and right based on a wheel body 211.

In FIG. 1, speeds of the wheels arranged at both sides of the differential wheel module may be independently adjusted, respectively. Through the above, the differential wheel module may freely change directions in a narrow space.

FIG. 2 is a diagram illustrating a link coupling structure of the robot apparatus 1 according to at least one embodiment of the disclosure.

In FIG. 2, the first wheel 201 and the second wheel 202 of the robot apparatus 1 may have a link coupling structure coupled to an upper part of the main body 100. Through the link coupling structure described above, the main body 100 may be maintained without shaking when the robot apparatus 1 is driving over an unstable ground surface.

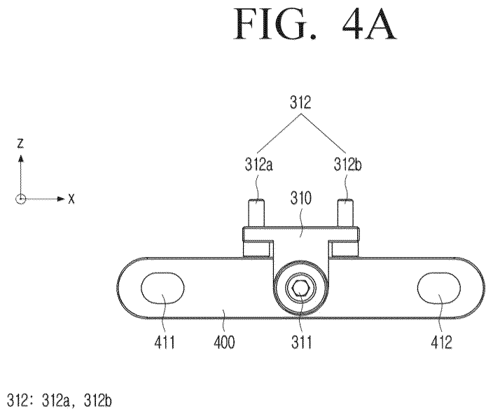

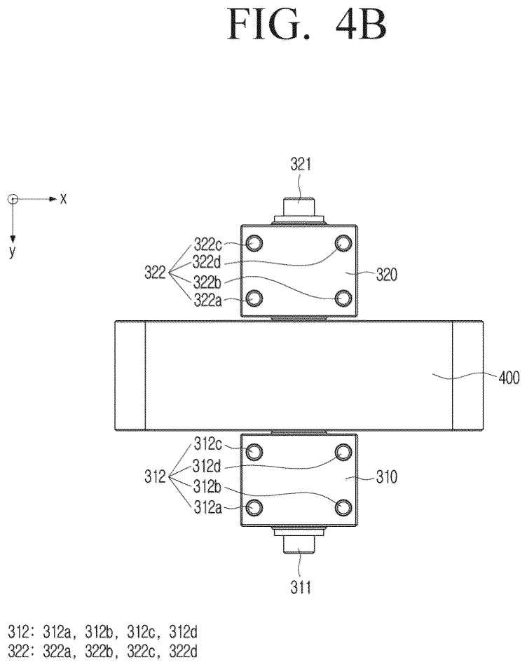

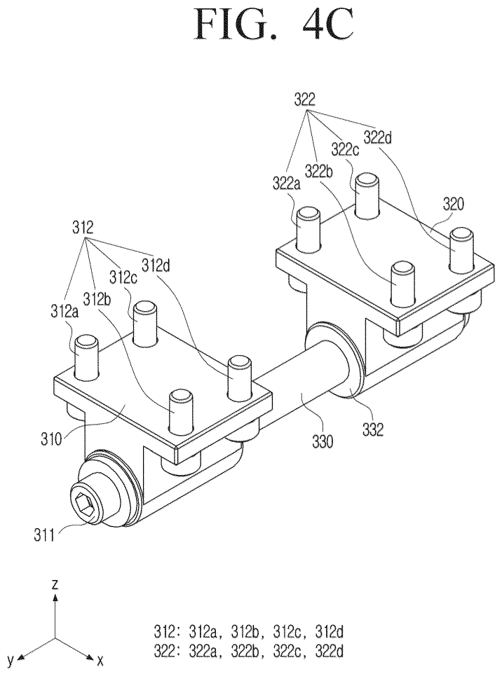

In FIG. 2, the robot apparatus 1 may include main hinges 310 and 320, a main link member 400, a plurality of sub-link members 510 and 520, first hinge members 610 (reference numerals 611 and 612 in FIG. 4), second hinge members 620 (reference numerals 621 and 622 in FIG. 4), the first wheel 201, and the second wheel 202.

In FIG. 2, the main hinges 310 and 320 may be fixed at the lower part of the main body 100. In the disclosure, the main hinges may be configurations connected with the main link member 400 which connects between the first wheel and the second wheel. The main hinges may be implemented as an integrated type, or may be implemented as a structure divided into two parts 310 and 320 as shown in FIG. 2. For convenience of description, these parts will be described as a first main hinge 310 and a second main hinge 320, respectively, and these two will be collectively described as the main hinges 310 and 320.

The first main hinge 310 and the second main hinge 320 may be fixed to the lower part of the main body 100 spaced apart by a certain distance from each other. The first main hinge 310 and the second main hinge 320 may be arranged oppositely to form a certain space therebetween. The main link member 400 may be arranged in the space between the first main hinge 310 and the second main hinge 320. A center part from among a whole configuration of the main link member 400 may be arranged in the space between the first main hinge 310 and the second main hinge 320.

In FIG. 2, the main link member 400 may be coupled with the main hinges 310 and 320 at the center part. The main link member 400 may be coupled with the first main hinge 310 and the second main hinge 320 between the first main hinge 310 and the second main hinge 320. Accordingly, the main link member 400 may be pivoted about the main hinges 310 and 320. When the robot apparatus 1 is driving on an unstable terrain, one end and other end of the main link member 400 may be pivoted in an upward or downward direction about the main hinges 310 and 320. That is, when the one end of the main link member 400 moves to an upward side based on the main hinges 310 and 320, the other end may move to a downward side.

In FIG. 2, the plurality of sub-link members 510 and 520 may be coupled at both sides of the main link member 400. The plurality of sub-link members 510 and 520 may be connected at both sides along a length direction of the main link member 400 (e.g., the x-axis direction). The plurality of sub-link members 510 and 520 may be coupled at outer side surface parts of both sides of the main link member 400. For convenience of description, among the plurality of sub-link members, that which is connected to a first end part which is one from among both end parts of the main link member 400 may be a first sub-link member 510, and that which is connected to a second end part which is the other one from among the both end parts may be a second sub-link member 520.

Each of the plurality of sub-link members may be respectively connected with the first hinge members 610 (reference numerals 611 and 612 in FIG. 4) and the second hinge members 620 (reference numerals 621 and 622 in FIG. 4) at the lower part of the main body. The plurality of sub-link members may be pivoted about the first hinge members 610 (reference numerals 611 and 612 in FIG. 4) and the second hinge members 620 (reference numerals 621 and 622 in FIG. 4) according to movements of the first wheel and the second wheel. At this time, a part connected to the main link member 400 in each sub-link member may be displaced together according to movements of the first wheel and the second wheel. Accordingly, even when a driving surface of the robot apparatus is uneven or inclined, operating stably may be possible.

One end of the plurality of sub-link members 510 and 520 may have grooves 510a and 520a formed at a center part thereof. Here, the one end of the plurality of sub-link members 510 and 520 may refer to a region position toward a direction facing the main hinges 310 and 320 of the robot apparatus 1 in the plurality of sub-link members 510 and 520.

A connectional structure of the main link member 400 and each sub-link member may be variously implemented according to an embodiment.

In an example, the main link member 400 may be inserted in the grooves 510a and 520a formed at the sub-link members 510 and 520. Then, the main link member 400 may be coupled with the sub-link members 510 and 520 which are arranged at an outer side thereof. Each of the plurality of sub-link members 510 and 520 may be connected with the main link member 400 through a hole formed at a region at which the plurality of sub-link members 510 and 520 are coupled with the main link member 400 at the lower part of the main body 100. The hole is not limited to a circular hole, and may have various shapes such as a slot. The slot in the disclosure may be a hole in a form where a length toward one direction is longer compared to a hole, that is, a hole of an elongated form. Accordingly, when a protruding part, a connecting part, or the like having a length shorter than a length of the slot is connected to the slot, the protruding part or the connecting part may be displaced in the slot. Accordingly, a connection angle between the main link member 400 and the sub-link members 510 and 520 may be changed in various directions, and as movement of the wheels at the lower part respond adaptively as a result thereof, a level (horizontality) of the main body may be maintained as much as possible. Various connection structures using slots will be described in detail again in the description below.

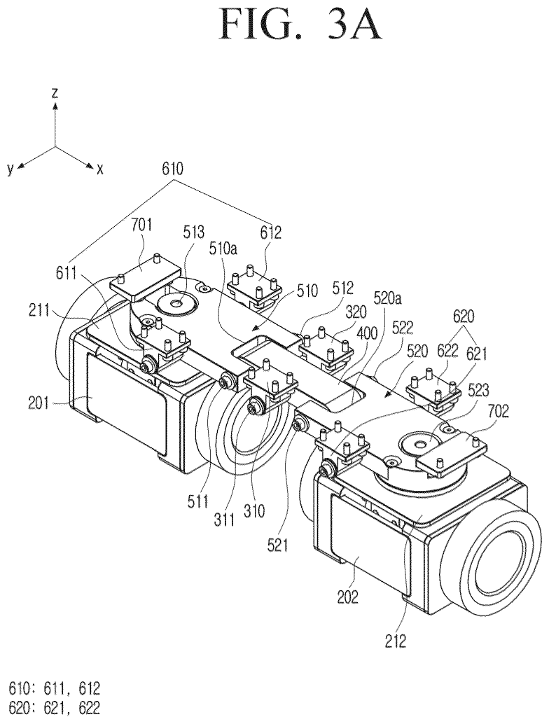

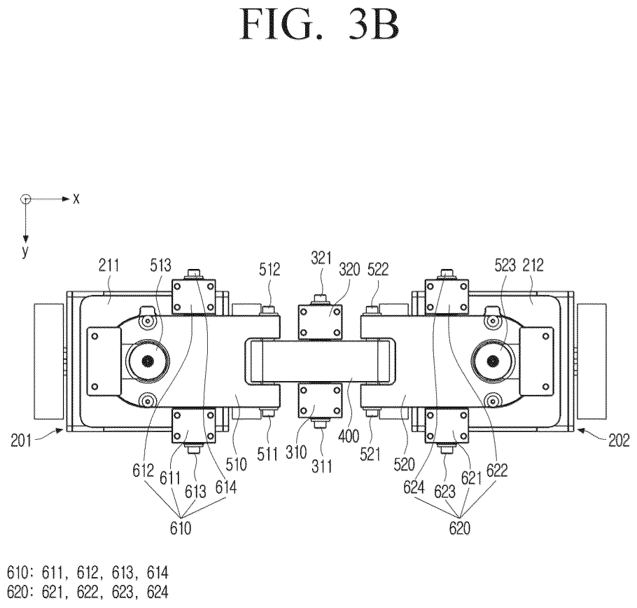

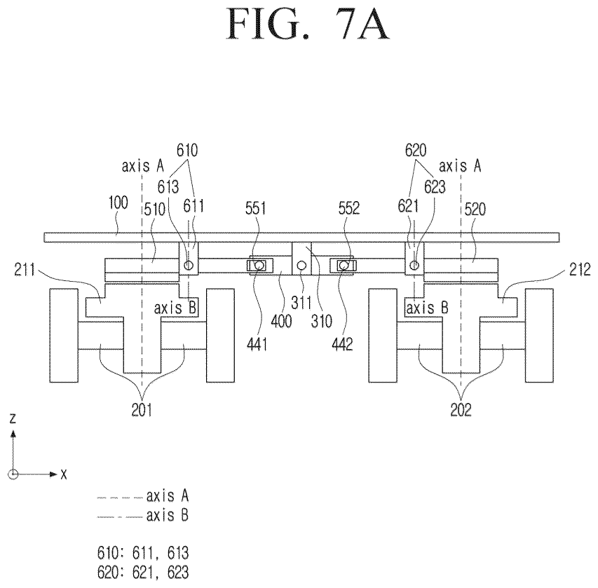

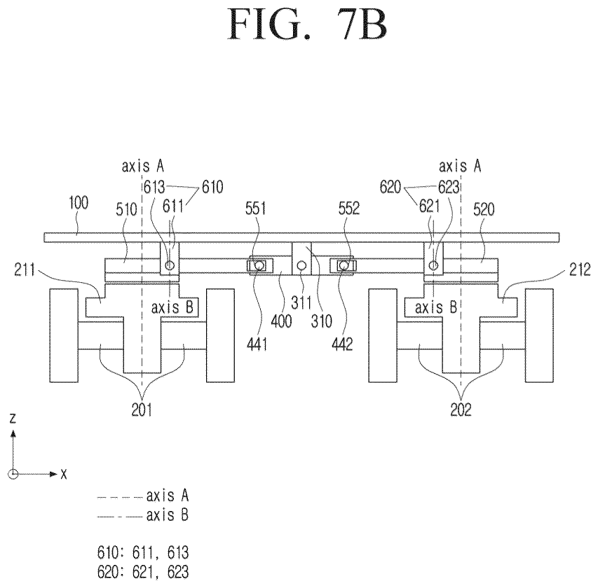

In FIG. 2, the first hinge members 610 (reference numerals 611 and 612 in FIG. 3A) and the second hinge members 620 (reference numerals 621 and 622 in FIG. 3A) may be fixed at positions spaced apart from the main link member 400 at the lower part of the main body 100. Each of the first hinge members (reference numerals 611 and 612 in FIG. 3A) and the second hinge members (reference numerals 621 and 622 in FIG. 3A) may be arranged at positions spaced apart by a certain distance from each other at the lower part of the main body 100. Each of the plurality of sub-link members 510 and 520 may be arranged at an inner side of the first hinge members (reference numerals 611 and 612 in FIG. 3A) and the second hinge members (reference numerals 621 and 622 in FIG. 3A) arranged at the lower part of the main body 100. In addition, each of the plurality of sub-link members 510 and 520 may be coupled with inner side surfaces of the first hinge members (reference numerals 611 and 612 in FIG. 3A) and the second hinge members (reference numerals 621 and 622 in FIG. 3A) arranged at the lower part of the main body 100. Each of the plurality of sub-link members 510 and 520 may be pivoted about the first hinge members (reference numerals 611 and 612 in FIG. 3A) and the second hinge members (reference numerals 621 and 622 in FIG. 3A) according to movement of the first wheel 201 and the second wheel 202. Accordingly, while a specific object is arranged at the upper part of the main body 100, even if a load of the specific object is concentrated toward one side while the robot apparatus 1 is driving, the robot apparatus 1 may not be overturned or flipped over. Because detailed descriptions with respect to the above will be provided in detail in FIG. 4 and FIG. 7, descriptions thereof will be omitted.

FIGS. 3A and 3B are diagrams illustrating a link coupling structure of the robot apparatus 1 according to at least one embodiment of the disclosure. Specifically, FIG. 3A is a perspective view of a link device coupled with the first wheel 201 and the second wheel 202, and FIG. 3B is a view illustrating an upper part of the link device coupled with the first wheel 201 and the second wheel 202. As used in the present disclosure, the term “link device,” also referred to as a “link member,” refers to a link-type (or link-based) suspension structure. A link-type suspension may be a mechanical structure used in wheeled systems to connect and control the movement of wheels relative to a main body or chassis. A series of rigid arms (links) and joints may be used to guide wheel movement, allowing for controlled vertical displacement (suspension travel) and accommodating steering or terrain adaptation.

In FIGS. 3A and 3B, the robot apparatus 1 may include the main hinges 310 and 320, the main link member 400, the plurality of sub-link members 510 and 520, the first hinge members (reference numerals 611 and 612 in FIG. 4), the second hinge members (reference numerals 621 and 622 in FIG. 4), the first wheel 201, and the second wheel 202.

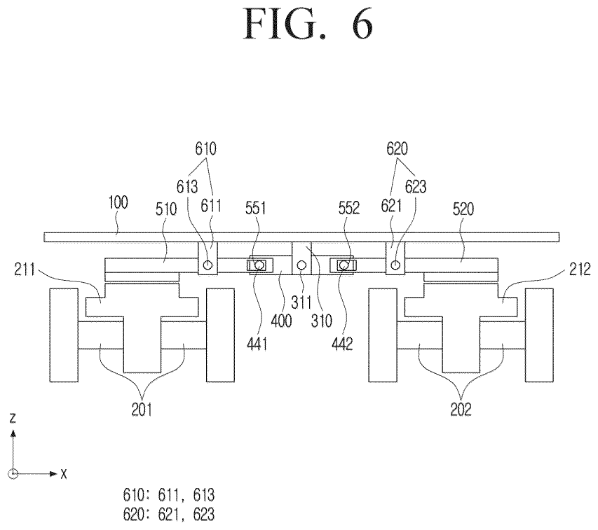

In FIGS. 3A and 3B, the main hinges 310 and 320 may be arranged at a center part of a front surface at a lower surface of the main body 100. In addition, the main hinges 310 and 320 may be coupled with the main link member 400 at the center part. The main hinges 310 and 320 may include fixing parts 311 and 321 at an outer side surface thereof. The fixing parts 311 and 321 may prevent the main link member 400 from being deviated from the main hinges 310 and 320 by fixing a connecting part (reference numeral 330 in FIG. 4C) which connects with the main link member 400. The main link member 400 may be coupled with the plurality of sub-link members 510 and 520 at both sides thereof. The plurality of sub-link members 510 and 520 may be formed with grooves 510a and 520a at a center part of one side end part. The plurality of sub-link members 510 and 520 may be respectively inserted with a side surface part of the main link member 400 in the grooves 510a and 520a. The plurality of sub-link members 510 and 520 may include a plurality of fixing parts 511, 512, 521, and 522 at an outer side surface of the one side end part. The plurality of fixing parts 511, 512, 521, and 522 may prevent the main link member 400 and the plurality of sub-link members 510 and 520 from being separated by fixing a connecting part (reference numeral 530 in FIG. 6) which connects with main link member 400.

In FIGS. 3A and 3B, the plurality of sub-link members 510 and 520 may be connected with a first hinge member 610 and a second hinge member 620 arranged at positions spaced apart from the main link member 400. The first hinge member 610 and the second hinge member 620 may be arranged at one region between one side end part and other side end part of the plurality of sub-link members 510 and 520. Here, the one side end part may be a region at which the plurality of sub-link members 510 and 520 and the main link member 400 are connected, and the other side end part may be a region at which each of the first wheel 201 and the second wheel 202 is coupled to the plurality of sub-link members 510 and 520.

In FIGS. 3A and 3B, the plurality of sub-link members 510 and 520 may include contacting parts 701 and 702 at an upper part of the other side end part. The contacting parts 701 and 702 may connect the main body 100 and the plurality of sub-link members 510 and 520, and fix the main body 100 and the plurality of sub-link members 510 and 520 to one another. The contacting parts 701 and 702 may reduce shaking generated by an empty space between the main body 100 and the plurality of sub-link members 510 and 520.

In FIGS. 3A and 3B, the first wheel 201 and the second wheel 202 may include a wheel body 211 and a differential wheel. The differential wheel may include a plurality of wheels arranged at both sides based on the wheel body 211. The wheel body 211 may be coupled with the plurality of sub-link members 510 and 520 at the upper side. Specifically, the wheel body 211 of the first wheel 201 and the second wheel 202 may include connecting members 513 and 523 at the upper part thereof. The connecting members 513 and 523 may be configurations that are connectable with each sub-link member through a hole formed at each of the plurality of sub-link members. The connecting members 513 and 523 may be formed integrally, or formed as different members. The connecting members 513 and 523 may be assembled at a hole formed at the other side end part of the plurality of sub-link members 510 and 520.

In FIGS. 3A and 3B, when a load is concentrated at either the first wheel 201 or the second wheel 202, the robot apparatus 1 may be prevented from overturning by the action of the main link member 400 and the plurality of sub-link members 510 and 520. For example, if a load is concentrated at the second wheel 202, the main link member 400 may rotate clockwise about the main hinges 310 and 320. When the main link member 400 rotates clockwise about the main hinges 310 and 320, a sub-link member 520 coupled with the second wheel 202 may rotate in an counter-clockwise direction. While the load on the second wheel 202 generates a clockwise rotational torque on the robot apparatus 1, the sub-link member 520 coupled with the second wheel 202 may generate the rotational torque in the counter-clockwise direction due to rotation in the counter-clockwise direction. Accordingly, the torque produced by the sub-link member 520 counteracts the clockwise torque, thereby helping to stabilize the robot apparatus 1 and prevent it from tipping over.

If the robot apparatus 1 receives a lateral force from a left side to a right side, the robot apparatus 1 may experience a clockwise rotational torque. In this situation, combined external and frictional forces acting on the first wheel 201 generate a vertical downward external force, a rotational torque in the counter-clockwise direction is generated based on the center of the robot apparatus 1. Likewise, because combined external and frictional forces acting on the second wheel 202 generate a vertical upward external force, a rotational torque in the counter-clockwise direction is generated based on the center of the robot apparatus 1. As a result, the rotational torque in the clockwise direction generated in the robot apparatus 1 may prevent the overturning of the robot apparatus 1 due to being offset by the rotational torque in the counter-clockwise direction generated by the link coupling structure.

In addition, even if the robot apparatus 1 drives over an unstable ground surface, at least three wheels from among a plurality of wheels 201, 202, 203, and 204 may be grounded with the ground surface through the link coupling structure through which the first wheel 201 and the second wheel 202 are coupled. Specifically, if the ground surface of the first wheel 201 is higher than the ground surface of the second wheel 202, the sub-link member 510 arranged at an upper side of the first wheel 201 may be rotated in the clockwise direction. As the sub-link member 510 arranged at the upper side of the first wheel 201 is rotated about the first hinge members 611 and 612 in the clockwise direction, the main link member 400 may be rotated about the main hinges 310 and 320 in the counter-clockwise direction. The main hinges 310 and 320 may be rotated in the counter-clockwise direction, and the sub-link member 520 arranged at an upper side of the second wheel 202 may be rotated about the second hinge members 621 and 622 in the clockwise direction to a point of contacting the ground surface of the second wheel 202. Through the above, even if the ground surface is unstable, driving may be possible while the first wheel 201 and the second wheel 202 of the robot apparatus 1 maintain contact with the ground surface. Further, one wheel from among a third wheel 203 and the fourth wheel 204 of the robot apparatus 1 has to maintain contact with the ground surface. Based on the above, as three wheels from among the four wheels of the robot apparatus 1 is contacted with the ground surface, the robot apparatus 1 may not be flipped over, and riving to a desired point may be completed.

FIGS. 4A, 4B, and 4C are diagrams illustrating a coupling relationship of the main hinges 310 and 320 and the main link member 400 of the robot apparatus 1 according to at least one embodiment of the disclosure.

In FIGS. 4A, 4B, and 4C, the first main hinge 310 and the second main hinge 320 may include a plurality of screw members 312 and 322 at the upper side thereof. The plurality of screw members 312 and 322 may fix the first main hinge 310 and the second main hinge 320 to the main body 100. In FIG. 4B, the plurality of screw members 312 and 322 has been coupled to the first main hinge 310 and the second main hinge 320 by four each, but is not necessarily limited thereto, and may be coupled through the plurality of screw members 312 and 322. The plurality of screw members 312 and 322 may include a head portion at a lower side thereof, and include with a neck portion at a middle side and an upper side thereof. Here, the head portion may have a wider cross-sectional width compared to the neck portion. Upper parts of the first main hinge 310 and the second main hinge 320 may include holes through which only the neck portion of the plurality of screw members 312 and 322 can pass. The plurality of screw members 312 and 322 may be coupled to the holes of the first main hinge 310 and the second main hinge 320.

The first main hinge 310 and the second main hinge 320 may include holes that pass through the inner side surfaces and the outer side surfaces thereof. The main link member 400 may include a hole that passes through the inner side surface and the outer side surface thereof at the center part. The main link member 400 may be arranged at the inner sides of the first main hinge 310 and the second main hinge 320. The connecting part 330 may be coupled to a hole that passes through the inner side surfaces and the outer side surfaces of the first main hinge 310, the second main hinge 320, and the main link member 400. After the main link member 400 and the main hinges 310 and 320 are coupled to the connecting part 330, the fixing parts 311 and 321 may be coupled together with the connecting part 330 at the outer side surfaces of the first main hinge 310 and the second main hinge 320. Through the configuration described above, the main hinges 310 and 320 and the main link member 400 may not be separated due to the connecting part 330 and the fixing parts 311 and 321. Through the coupling described above, the main link member 400 may be pivoted about the connecting part 330 in the clockwise direction, or in the counter-clockwise direction.

The main link member 400 may be included with slots 411 and 412 at both side parts. The slots 411 and 412 may have elongated through-hole shapes. The slots 411 and 412 of the main link member 400 may be assembled with the plurality of sub-link members 510 and 520 through a connecting part (reference numeral 530 in FIG. 6). While the robot apparatus 1 is driving, the connecting part (reference numeral 530 in FIG. 6) left and right inside the slots 411 and 412 of the main link member 400.

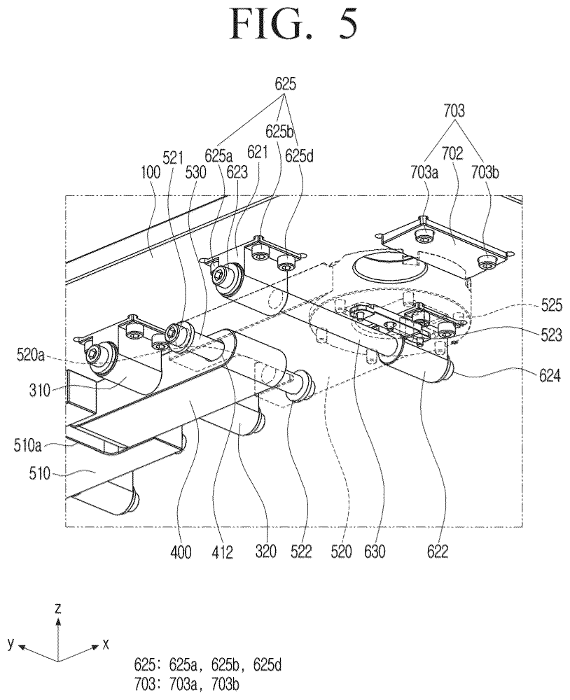

FIG. 5 is a diagram illustrating a coupling relationship of the main link member 400 and the sub-link members 510 and 520 of the robot apparatus 1 according to at least one embodiment of the disclosure.

In FIG. 5, a coupling relationship based on the sub-link member 520 to which the second wheel 202 is coupled and the main link member 400 will be described, but the sub-link member 510 to which the first wheel 201 is coupled may also have the same coupling relationship with the main link member 400.

In FIG. 5, the sub-link member 520 may be formed with a groove 510a at the center part of the one side end part. The groove 520a of the sub-link member 520 may be formed in a size that the side surface part of the main link member 400 can be inserted. The one side end part of the sub-link member 520 may include a hole that passes through the outer side surface and the inner side surface. The connecting part 530 may be assembled in a hole formed at a slot 412 of the main link member 400 and the one side end part of the sub-link member 520. A plurality of fixing parts 521 and 522 may be assembled at a side surface part of the connecting part 530 at the outer side surface of the sub-link member 520. Through the above, the connecting part 530 and the plurality of fixing parts 521 and 522 may prevent the main link member 400 and the sub-link member 520 from being separated.

The second hinge members 621 and 622 may be coupled at a lower side of the main body 100 through a plurality of screw parts 625. Because a structure of the plurality of screw parts 625 is the same as a structure of screw parts 312 and 322 in FIGS. 4A, 4B, and 4C, descriptions thereof will be omitted. Each of the second hinge members 621 and 622 may be arranged at positions spaced apart from each other at both side surfaces of the sub-link member 520. The sub-link member 520 may be arranged at the inner side surfaces of the second hinge members 621 and 622. Each of the second hinge members 621 and 622 may include a hole that passes through the inner side surface and the outer side surface. In addition, the sub-link member 520 may include a hole that passes through each outer side surface. A third connecting part 630 may be assembled in a hole that passes through the hole of the second hinge members 621 and 622 and each outer side surface of the sub-link member 520. The plurality of fixing parts 623 and 624 may be coupled at an outer side part of the third connecting part 630 at the outer side surfaces of the second hinge members 621 and 622. Accordingly, a sub-link member 620 may not be separated from the second hinge members 621 and 622. In addition, the sub-link member 620 may be pivoted about the third connecting part 630.

The sub-link member 620 may be coupled with a contacting part 702 at other side end part thereof. The contacting part 702 may be coupled with the main body 100 at the upper part thereof through a plurality of screw parts 703 like the main hinges 310 and 320 and the second hinge members 621 and 622. A center part of the other side end part of the sub-link member 620 may include a hole that passes through a lower side and upper side thereof. The sub-link member 620 may be coupled with a connecting member 523 arranged at an upper side part of a wheel body 212 of the second wheel 202 in a hole formed at the other side end part. In addition, the sub-link member 620 may be coupled with the upper side part of the wheel body 212 of the second wheel 202 at the other side end part through a plurality of screw parts 525.

FIG. 6 is a diagram illustrating a coupling relationship of the main link member 400 and the plurality of sub-link members 510 and 520 of the robot apparatus 1 according to at least one embodiment of the disclosure.

In FIG. 4A to FIG. 4C, the main link member 400 an the plurality of sub-link members 510 and 520 may be formed with the slot 412 at both side parts of the main link member 400, and have a structure which is coupled with one another through the connecting part 530, but the main link member 400 and the plurality of sub-link members 510 and 520 in FIG. 6 may be coupled with one another through a different structure from that of FIG. 4A to FIG. 4C.

In FIG. 6, the main link member 400 may be formed with protruding parts 441 and 442 at both side surfaces of both side parts thereof. A cross-section of the protruding parts 441 and 442 may be in a circular shape. However, the embodiment is not limited thereto, and the cross-section of the protruding parts 441 and 442 may have various shapes.

In FIG. 6, the plurality of sub-link members 510 and 520 may be formed with slots 551 and 552 at one side end part thereof. The protruding parts 441 and 442 of the main link member 400 may be connected with the plurality of sub-link members 510 and 520 through the slots 551 and 552. The protruding parts 441 and 442 of the main link member 400 may include separation preventing members (not shown) at both side parts. Through the above, the main link member 400 and the plurality of sub-link members 510 and 520 may not be separated by the separation preventing members (not shown).

In FIG. 6, each of the plurality of sub-link members 510 and 520 may be connected to first and second hinge members 613 and 623 at positions separated from the main link member 400 at the lower part of the main body 100. The each of the plurality of sub-link members 510 and 520 may be connected with the main link member 400 through the slots 551 and 552 which are formed at a region that is coupled with the main link member 400. The each of the plurality of sub-link members 510 and 520 may be pivoted about the first and second hinge members 613 and 623 according to movement of the first wheel 201 and the second wheel 202.

In FIG. 6, the plurality of sub-link members 510 and 520 may be connected at both sides of the main link member 400 along the length direction. Each of the slots 551 and 552 of the plurality of sub-link members 510 and 520 may be formed at the one side end part that connects with the main link member 400. Each of the first wheel 201 and the second wheel 202 may be connected to the other side end part of each of the plurality of sub-link members 510 and 520. The each of the first and second hinge members 613 and 623 may be connected at one region between the one side end part and the other side end part.

Although not shown in FIG. 6, the main link member 400 may include a main hole in place of the protruding parts 441 and 442 at both side surfaces of the both side parts thereof. The main link member 400 may be coupled with the plurality of sub-link members 510 and 520 using connecting parts positioned at each of the slots 551 and 552 of the main hole and the plurality of sub-link members 510 and 520. Here, the main hole of the main link member 400 may be in a slot shape.

Each of the first and second hinge members 613 and 623 may include a plurality of hinge parts 611, 612, 621, and 622 arranged spaced apart at both side surfaces of the plurality of sub-link members 510 and 520. In addition, each of the first and second hinge members 613 and 623 may include a plurality of connecting parts 630 coupled with the plurality of sub-link members 510 and 520 at the inner side of the plurality of hinge parts 611, 612, 621, and 622. Although the plurality of hinge parts 611, 612, 621, and 622 is referred as if it is different from the first and second hinge members 613 and 623, the above may be referred as same members.

FIGS. 7A and 7B are diagrams illustrating a positional relationship of a first hinge member 613 and a second hinge member 623 of the robot apparatus 1 according to at least one embodiment of the disclosure. In some embodiments of the disclosure, a rotation axis A of a wheel module (e.g., the rotation axis A of the first wheel module 201) may be different from a hinge axis B of a corresponding link member (e.g., the hinge axis B of the first hinge part 611). For example, the hinge axis B of the first hinge part 611 may be positioned closer to the center axis of the robot apparatus 1, compared to the rotation axis A of the first wheel module 201. Similarly, the hinge axis B of the second first hinge part 621 may be positioned closer to the center axis of the robot apparatus 1, compared to the rotation axis A of the second wheel module 202.

In FIGS. 7A and 7B, each of the first hinge member 613 and the second hinge member 623 of the robot apparatus 1 may be connected at one region between the one side end part and the other side end part of a plurality of sub-link members 510 and 520. Here, the one side end part may be the region at which the plurality of sub-link members 510 and 520 is connected with the main link member 400, and the other side end part may be the region at which the plurality of sub-link members 510 and 520 is connected with the first wheel 201 and the second wheel 202.

In FIG. 7A, the first hinge member 613 may include a plurality of first hinge parts 611 and 612 which is arranged opposite to each other at a first position which is spaced apart from the main link member 400 at the lower part of the main body 100. The first hinge member 613 may include a first connecting part that connects the plurality of first hinge parts 611 and 612 and the first sub-link member 510 while the first sub-link member 510 which is one from among the plurality of sub-link members is arranged between the plurality of first hinge parts 611 and 612.

The second hinge member 623 may include a plurality of second hinge parts 621 and 622 arranged opposite to each other at a second position which is spaced apart from the main link member 400 at the lower part of the main body 100. In addition, the second hinge member 623 may include a second connecting part that connects the plurality of second hinge parts 621 and 622 and the second sub-link member 520 while the second sub-link member 520 which is the other one from among the plurality of sub-link members is arranged between the plurality of second hinge parts 621 and 622.

In FIG. 7A, the first hinge member 613 and the second hinge member 623 may be arranged at a region closer with the main link member 400 between the one side end part and the other side end part compared to that of FIG. 7B. Opposite to the above, in FIG. 7B, the first hinge member 613 and the second hinge member 623 may be arranged at a region closer with the first wheel 201 and the second wheel 202 between the one side end part and the other side end part. That is, the first hinge member 613 may be arranged at a point closer to the other side end part based on the center between the one side end part and the other side end part at which a slot 551 is formed from among the both end parts of each of the first sub-link members 510. In addition, the second hinge member 623 may be arranged at a point closer to the other side end part based on the center between the one side end part and the other side end part at which a slot 552 is formed from among both end parts of each of the second sub-link members 520.

Referring to FIG. 7A, if the first hinge member 613 and the second hinge member 623 are close to a main link member 400, the first hinge member 613 and the second hinge member 623 may distribute a load of an object positioned at the upper part of the main body 100 to each of the main link member 400 and the plurality of sub-link members 510 and 520. Through the above, damage to each component of the main link member 400 and the plurality of sub-link members 510 and 520 may be reduced.

Referring to FIG. 7B, if the first hinge member 613 and the second hinge member 623 are close with the first wheel 201 and the second wheel 202, the first hinge member 613 and the second hinge member 623 may become farther part from a center axis of the robot apparatus 1. Due to the above, if the robot apparatus 1 receives a lateral force, a rotational torque of the robot apparatus 1 which offsets a rotational torque caused by the lateral force may become greater. Accordingly, a magnitude of necessary force may become greater compared to FIG. 7A because the robot apparatus 1 may be overturned. As a result, the robot apparatus 1 may drive stably without being overturned even if an even greater lateral force is applied.

The positions of the first hinge member 613 and the second hinge member 623 arranged between the one side end part and the other side end part in FIGS. 7A and 7B may be varied according to stability of components, driving stability of the robot apparatus 1, a grounding force of the robot apparatus 1, and the like.

In addition, in FIGS. 7A and 7B, if the robot apparatus 1 receives lateral force from the left side to the right side, a vertical load applied to the first wheel 201 and the second wheel 202 may be increased at the second wheel 202 and reduced at the first wheel 201. Here, if the robot apparatus 1 is not overturned, a total vertical load may be same as an initial state, but the moment the first wheel 201 loses braking force, the second wheel 202 may receive a greater vertical load, and a greater braking force may be generated at the second wheel 202. In addition, as the positions of the first hinge member 613 and the second hinge member 623 become farther from the main link member 400, the vertical load applied to the first wheel 201 and the second wheel 202 may become greater.

FIG. 8 is a diagram illustrating the robot apparatus 1 further including a support plate 103 according to at least one embodiment of the disclosure.

The robot apparatus 1 may include the main body 100. The main body 100 may include a first support plate 101. The first support plate 101 may be arranged at an upper side of the plurality of wheels 201, 202, and 204. Each of a plurality of support parts 102 may be arranged at an upper side of the first support plate 101. The plurality of support parts 102 may include a number of at least two or more. In FIG. 8, each of the plurality of support parts 102 may be arranged near each corner of the first support plate 101. For example, a first support part 102a may be arranged near a corner of a region at which the first wheel 201 is positioned at the upper side of the first support plate 101, a second support part 102b may be arranged near a corner of a region at which the second wheel 202 is positioned, a third support part (not shown) may be arranged near a corner of a region at which the third wheel 203 is positioned, and a fourth support part 102d may be arranged near a corner of a region at which the fourth wheel 204 is positioned.

A second support plate 103 may be arranged at an upper side of the plurality of support parts 102. Specifically, the second support plate 103 may be coupled with the plurality of support parts 102 in a parallel state with the first support plate 101 and spaced apart by a height of the plurality of support parts 102 in a +Z-axis direction.

In FIG. 8, a cross-section of the first support plate 101 may be a square. However, the embodiment is not limited thereto, and the cross-section of the first support plate 101 may have various shapes such as a circular shape, an elliptical shape, and a polygonal shape. The shapes of the first support plate 101 and the second support plate 103 may be the same shape. However, the embodiment is not limited thereto, and the first support plate 101 and the second support plate 103 may respectively have various different shapes.

Although not shown in FIG. 8, the plurality of support parts 102 may be coupled to an upper part of the second support plate 103. Then, a third support plate (not shown) may be coupled to the upper side of the plurality of support parts 102 arranged at the upper part of the second support plate 103. As described, the main body 100 may variously adjust the number of the plurality of support parts 102 and the support plates according to a purpose thereof.

FIG. 9 is a diagram illustrating the robot apparatus 1 further including a 3-axis core robot according to at least one embodiment of the disclosure.

In FIG. 9, the robot apparatus 1 may include the main body 100. At the upper part of the main body 100, a 3-axis core robot (e.g., a 3-axis robot arm) may be assembled. The 3-axis core robot may be otherwise referred to as a humanoid device. The humanoid device may be mounted on the main body 100 of the robot apparatus 1.

The 3-axis core robot may be a robot capable of performing a specific task after the robot apparatus 1 drives to a specific position. For example, the 3-axis core robot may perform a function of transporting hazardous materials, perform a function of transporting heavy loads, or the like. However, the embodiment is not limited thereto, and the 3-axis core robot may perform various tasks.

In FIG. 9, the 3-axis core robot arranged at the upper part of the robot apparatus 1 may include a main module 1000, an I-type module 2000, a plurality of L-type modules 3010, 3020, and 3030, and an end effector module 4000. Specifically, the main module 1000 may be arranged at the upper side of the main body 100 of the robot apparatus 1. The I-type module 2000 may be assembled at a center part of the upper side of the main body 100. A first L-type module 3010 may be assembled at one end of the I-type module 2000. A second L-type module 3020 may be assembled at one end of the first L-type module 3010. A third L-type module 3030 may be assembled at one end of the second L-type module 3020. The end effector module 4000 may be assembled at one end of the third L-type module 3030. In FIG. 9, the 3-axis core robot has been described, but the embodiment is not necessarily limited thereto. For example, another robot assembled at the upper part of the robot apparatus 1 may be a 4-axis core robot, or may be a core robot of various shapes formed by assembling various modules.

Because the robot apparatus 1 is assembled as the 3-axis core robot, the load applied to the plurality of wheels 201, 202, 203, and 204 may become greater. In addition, while the end effector module 4000 of the 3-axis core robot is performing a task, external force may be generated from the external environment impacting the robot apparatus 1, and the load may be concentrated at a specific wheel from among the plurality of wheels 201, 202, 203, and 204. Due to the above, the robot apparatus 1 may be flipped over or overturned. At this time, through the coupling structure of the main hinges 310 and 320, the main link member 400, the plurality of sub-link members 510 and 520, the first hinge members 611 and 612, and the second hinge members 621 and 622 described in FIG. 1 to FIG. 7, the robot apparatus 1 may be prevented from being overturned due to an offsetting rotational torque being generated even if a greater lateral force or external force is applied and the load is concentrated at a specific wheel.

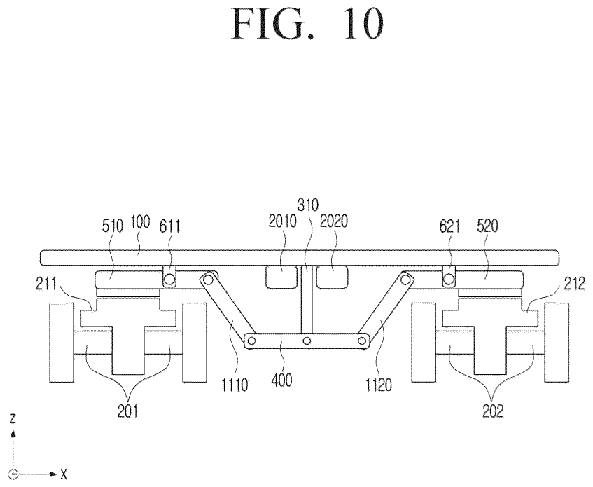

FIG. 10 is a diagram illustrating a robot apparatus including additional link members according to at least one embodiment of the disclosure.

In FIG. 10, the robot apparatus 1 may include the main body, a plurality of wheels 201 and 202, the main hinge 310, the main link member 400, the plurality of sub-link members 510 and 520, additional link members 1110 and 1120, and additional structures 2010 and 2020.

In FIG. 10, the main hinge 310 may have a longer shape compared to the main hinge in FIG. 2. Accordingly, the main link member 400 arranged at one end of the main hinge 310 may be arranged at a side lower than the sub-link members 510 and 520. In addition, the main link member 400 and the sub-link members 510 and 520 may have shorter lengths respectively compared to that in FIG. 2.

Both ends of the additional link members 1110 and 1120 may be respectively connected to one end of the main link member 400 and one end of the sub-link members 510 and 520. The additional link members 1110 and 1120 may be a structure that face downwards the closer the additional link members 1110 and 1120 are to the center part of the robot apparatus 1. That is, the additional link members 1110 and 1120 may be a structure that faces one end of the main link member 400 the closer the additional link members 1110 and 1120 are to the center part of the robot apparatus 1. Accordingly, a space in which the additional structures 2010 and 2020 can be installed may be formed between the sub-link members 510 and 520 and the main hinge 310. In addition, the first hinge member 611 and the second hinge member 612 may be arranged between a region where the sub-link members 510 and 520 and the additional link members 1110 and 1120 meet and a region where the plurality of wheels 201 and 202 meet.

The additional structures 2010 and 2020 may be arranged between the sub-link members 510 and 520 and the main hinge 310. The additional structures 2010 and 2020 may be formed as structures capable of reinforcing rigidity of the robot apparatus 1. For example, various structures such as structures, reinforcing plates, and truss structures capable of forming a bracing structure through a metal material member in a X-shape or a V-shape form may be arranged.

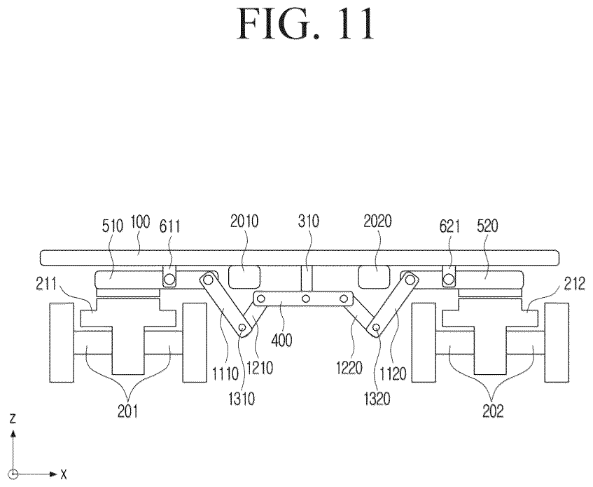

FIG. 11 is a diagram illustrating the robot apparatus 1 including the additional link members and sub-additional link members according to at least one embodiment of the disclosure.

In FIG. 11, the robot apparatus 1 may further include sub-additional link members 1110 and 1120 in FIG. 10. The main hinge 310 may be longer compared to the main hinge in FIG. 2, and may be in a shorter form compared to the main hinge in FIG. 10. The main link member 400 may be coupled to the lower side of the main hinge 310.

In FIG. 11, one end of the sub-additional link members 1110 and 1120 may be coupled to both ends of the main link member 400. The one end of the additional link members 1110 and 1120 may be coupled to one end of the sub-link members 510 and 520. The remaining one end of the sub-additional link members 1210 and 1220 may be coupled with the remaining one end of the additional link members 1110 and 1120. A region where the remaining one end of the sub-additional link members 1210 and 1220 and the remaining one end of the additional link members 1110 and 1120 are coupled may be positioned at a side lower than the main link member 400 and the sub-link members 510 and 520. Accordingly, at an upper side of the region where the remaining one end of the sub-additional link members 1210 and 1220 and the remaining one end of the additional link members 1110 and 1120 are coupled, a space in which the additional structures 2010 and 2020 can be arranged may be formed.

In addition, the first hinge member 611 and the second hinge member 612 may be arranged between the region where the sub-link members 510 and 520 and the additional link members 1110 and 1120 meet and the region where the plurality of wheels 201 and 202 meet.

The additional structures 2010 and 2020 may be arranged between the region where the remaining one end of the sub-additional link members 1210 and 1220 and the remaining one end of the additional link members 1110 and 1120 are coupled and a region at the lower part of the main body 100. The additional structures 2010 and 2020 may have various shapes and structures. Accordingly, the rigidity of the lower part of the robot apparatus 1 may be reinforced. Each of the elements described in the disclosure may be configured with one or more components, and the names of the relevant elements may change according to types of robot apparatuses.

In the disclosure, although the main body 100 of the robot apparatus 1 has been described as being assembled with various devices such as a support part, a support plate, a humanoid device, and a 3-axis core robot at the upper part thereof, but the main body 100 may be formed integrally with various devices described above.

In the above, various embodiments of the disclosure have been described individually, but the respective embodiments may not necessarily be implemented on its own, and the configuration and operation of the respective embodiments may be implemented in combination with at least one other embodiment.

While the disclosure has been illustrated and described with reference to example embodiments thereof, it will be understood that the embodiments are intended to be illustrative, not limiting. It will be understood by those skilled in the art that various changes in form and details may be made therein without departing from the true spirit and full scope of the disclosure, including the appended claims and their equivalents.

What is claimed is:

1. A robot apparatus, comprising:
a main body;
a main hinge positioned at a lower part of the main body;
a main link member having a center part coupled to the main hinge and configured to pivot about the center part;
a plurality of sub-link members coupled at both sides of the main link member; and
a first wheel and a second wheel connected to each of the plurality of sub-link members,
wherein each of the plurality of sub-link members is connected to a first hinge member and a second hinge member at positions spaced apart from the main link member at the lower part of the main body, and is configured to pivot about the first hinge member and the second hinge member according to movements of the first wheel and the second wheel.

2. The robot apparatus of claim 1, wherein
each of the plurality of sub-link members comprises a slot,
the main link member comprises a protruding part corresponding to the slot,
each of the plurality of sub-link members is connected to the main link member based on the protruding part being inserted into the slot, and
the slot is configured to allow displacement of the protruding part according to movement of the plurality of sub-link members.

3. The robot apparatus of claim 2, wherein
the plurality of sub-link members comprise a first sub-link member connected to a first end part of the main link member, and a second sub-link member connected to a second end part of the main link member,
the slot is formed at one side end part connected with the main link member from among both end parts of each of the first sub-link member and the second sub-link member,
each of the first wheel and the second wheel is connected to the other side end part from among the both end parts of each of the plurality of sub-link members,
the first hinge member is connected at one region between both end parts of the first sub-link member, and
the second hinge member is connected at one region between both end parts of the second sub-link member.

4. The robot apparatus of claim 1, wherein
both end parts of the main link member comprise slots,
one end part of each of the plurality of sub-link members comprises a hole,
the plurality of sub-link members is coupled to the main link member via a connecting part that passes through the hole and the slots, and
each of the slots is configured to allow displacement of the connecting part which is connected to the hole, according to movement of the plurality of sub-link members.

5. The robot apparatus of claim 1, wherein
each of the first wheel and the second wheel is a differential wheel comprising a wheel body and a plurality of sub-wheels arranged at both sides of the wheel body.

6. The robot apparatus of claim 5, wherein
the wheel body comprises connecting members coupleable to each of the plurality of sub-link members via holes formed at each of the plurality of sub-link members.

7. The robot apparatus of claim 6, further comprising:
a third wheel and a fourth wheel fixed at positions spaced apart from the first wheel and the second wheel at the lower part of the main body.

8. The robot apparatus of claim 7, wherein
each of the third wheel and the fourth wheel is a differential wheel comprising a wheel body and a plurality of sub-wheels arranged at both sides of the wheel body.

9. The robot apparatus of claim 1, wherein
the first hinge member comprises:
a plurality of first hinge parts arranged opposite to each other at a first position which is spaced apart from the main link member at the lower part of the main body; and
a first connecting part that connects the plurality of first hinge parts to a first sub-link member, wherein the first sub-link member, which is one of the plurality of sub-link members, is positioned between the plurality of first hinge parts, and
the second hinge member comprises:
a plurality of second hinge parts arranged opposite to each other at a second position which is spaced apart from the main link member at the lower part of the main body; and
a second connecting part that connects the plurality of second hinge parts to a second sub-link member, wherein the second sub-link member, which is the other of the plurality of sub-link members, is positioned between the plurality of second hinge parts.

10. The robot apparatus of claim 2, wherein
the first hinge member is positioned closer to an opposite end, relative to a center between two end parts of the first sub-link members, and
the second hinge member is positioned closer to an opposite end, relative to a center between two end parts of the second sub-link members.

11. The robot apparatus of claim 1, further comprising:
a humanoid device mounted on the main body.

12. The robot apparatus of claim 1, further comprising:
additional link members between the main link member and the plurality of sub-link members,
wherein the main link member positioned closer to a ground surface than the plurality of sub-link members.

13. The robot apparatus of claim 12, further comprising:
sub-additional link members between the additional link members and the main link member,
wherein a region where the additional link members and the sub-additional link members meet is positioned closer to the ground surface than a region where the main link member is positioned.

14. A robot apparatus comprising:
a main body;
a first wheel and a second wheel positioned at a lower part of the main body;
a main hinge positioned between the first wheel and the second wheel ;
a main link suspension having a central part coupled to the main hinge and configured to pivot about the central part;
a first sub-link suspension mounted on the first wheel, coupled to a first opposing side of the main link suspension, and comprising a first hinge that connects the first sub-link suspension to the lower part of the main body;
a second sub-link suspension mounted on the second wheel, coupled to a second opposing side of the main link suspension, and comprising a second hinge that connects the second sub-link suspension to the lower part of the main body;
wherein a hinge axis of the first hinge is positioned closer to the central part of the main link suspension than a rotation axis of the first wheel, and
wherein a hinge axis of the second hinge is positioned closer to the central part of the main link suspension than a rotation axis of the second wheel.
